(19) United States
(12) Patent Application Publication
(10) Pub. No.: US 2025/0323587 A1
(43) Pub. Date: Oct. 16, 2025

(54) METHOD AND CONTROLLER FOR CONTROLLING A BRUSHLESS DC MOTOR

(71) Applicant: Infineon Technologies Austria AG, Villach (AT)

(72) Inventors: Hamid Mahmoudi, Mission Viejo, CA (US); Hrach Amirkhanian, North Hills, CA (US); Vatche Oknaian, Henderson, NV (US)

(21) Appl. No.: 18/634,117

(22) Filed: Apr. 12, 2024

(51) Int. Cl. H02P 6/14; H02P 6/10

(52) U.S. Cl. CPC H02P 6/14; H02P 6/10

(57) ABSTRACT

A method of controlling a BLDC (brushless DC) motor having a plurality of phases each energized by a different leg of an inverter includes: generating a trapezoidal current reference signal for each phase of the BLDC motor that has a current ramp-up phase with a step profile along which the trapezoidal current reference signal has zero slope for a portion of the current ramp-up phase and non-zero slope elsewhere, and a current ramp-down phase with a step profile along which the trapezoidal current reference signal has zero slope for a portion of the current ramp-down phase and non-zero slope elsewhere; and adjusting a duty cycle of a switching control signal for each leg of the inverter, such that a current through each inverter leg is forced to follow the trapezoidal current reference signal for the corresponding phase. A corresponding controller is also described.

### BACKGROUND

BLDC (brushless DC) motors are widely used in various applications such as battery and lower power applications. In a BLDC motor, current flows through a body diode of the inverter switches during commutation which creates significant power loss and torque ripple. Additional sensing and logic circuits may be provided to detect demagnetization. However, system cost increases by adding a sensing circuit on all the switches and the additional logic to control the switches during demagnetization. Also, torque ripple during demagnetization is not addressed. A predetermined switching pattern may be used to control the inverter switches. Such an approach requires significant effort in finding an ideal pre-determined switching pattern. Also, this approach is not robust against disturbances and nonlinear behavior of the system, such as variation in temperature, saturation, and aging.

Thus, there is a need for an improved control technique for controlling BLDC motors.

### SUMMARY

According to an embodiment of a method of controlling a BLDC (brushless DC) motor having a plurality of phases each energized by a different leg of an inverter, the method comprises: generating a trapezoidal current reference signal for each phase of the BLDC motor that has a current ramp-up phase with a step profile along which the trapezoidal current reference signal has zero slope for a portion of the current ramp-up phase and non-zero slope elsewhere, and a current ramp-down phase with a step profile along which the trapezoidal current reference signal has zero slope for a portion of the current ramp-down phase and non-zero slope elsewhere; and adjusting a duty cycle of a switching control signal for each leg of the inverter, such that a current through each inverter leg is forced to follow the trapezoidal current reference signal for the corresponding phase.

According to an embodiment of a controller for a BLDC motor having a plurality of phases each energized by a different leg of an inverter, the controller comprises: a signal generator configured to generate a trapezoidal current reference signal for each phase of the BLDC motor that has a current ramp-up phase with a step profile along which the trapezoidal current reference signal has zero slope for a portion of the current ramp-up phase and non-zero slope elsewhere, and a current ramp-down phase with a step profile along which the trapezoidal current reference signal has zero slope for a portion of the current ramp-down phase and non-zero slope elsewhere; and a control loop for each phase of the BLDC motor and that is configured to adjust a duty cycle of a switching control signal for the inverter leg that energizes the phase, such that a current through the inverter leg is forced to follow the trapezoidal current reference signal for the phase.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a block diagram of a controller for a BLDC (brushless DC) motor.

FIG. 2 illustrates a trapezoidal current reference signal generated by the controller for a phase of the BLDC motor.

FIG. 3 illustrates phase-shifted trapezoidal current reference signals generated by the controller for three phases of the BLDC motor.

FIG. 4 illustrates a rotor position estimate waveform and the resulting trapezoidal current reference signal waveform generated by the signal generator for a phase of the BLDC motor.

FIG. 5 illustrates various waveforms associated with controlling the BLDC motor using the trapezoidal current reference signal for the nth phase of the motor.

FIG. 6 illustrates a block diagram of an embodiment of the control loop for each phase of the BLDC motor.

FIG. 7 illustrates a block diagram of an embodiment of the modulation function of the BLDC motor controller.

### DETAILED DESCRIPTION

The embodiments described herein provide a controller and method for controlling BLDC (brushless DC) motors. The controller and method perform switching during commutation and force current to flow through the power switch devices of the inverter stage instead of the body diodes. The controller and method gradually ramp the motor phase currents up and down during demagnetization and force each phase current to flow through the corresponding power switch device instead of the body diode. To this end, the controller and method generate a trapezoidal current reference signal for each phase of the BLDC motor. Each trapezoidal current reference signal has a current ramp-up phase with a step profile along which the trapezoidal current reference signal has zero slope for a portion of the current ramp-up phase and non-zero slope elsewhere, and a current ramp-down phase with a step profile along which the trapezoidal current reference signal has zero slope for a portion of the current ramp-down phase and non-zero slope elsewhere. The duty cycle of the switching control signal for each leg of the inverter stage is adjusted, such that the current through each inverter leg is forced to follow the trapezoidal current reference signal for the corresponding phase. That is, each trapezoidal current reference signal serves as a pattern, model, or example for the corresponding motor phase current such that the motor phase current resembles but does not necessarily identically match the trapezoidal current reference signal.

Described next, with reference to the figures, are exemplary embodiments of the method and controller for controlling BLDC motors.

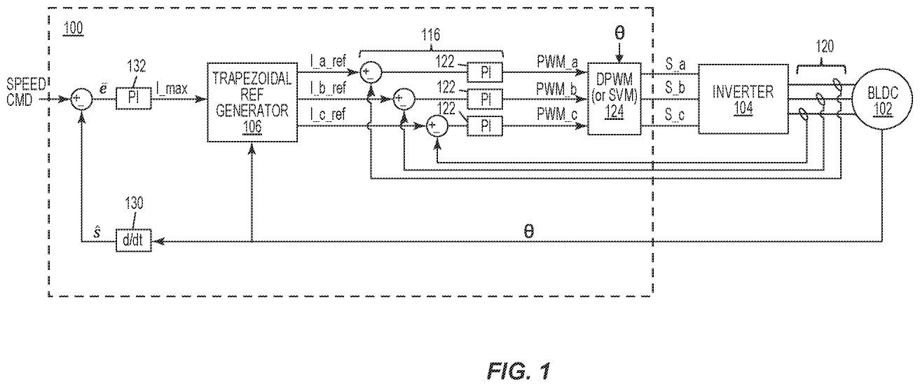

FIG. 1 illustrates a block diagram of a controller 100 for a BLDC motor 102 having a plurality of phases each energized by a different leg of an inverter stage 104. The BLDC motor 102 has no brushes. Instead, flux created in the stator interacts with flux in the rotor to turn the motor 102. The controller 100 generates currents in the rotor using the inverter stage 104. The inverter stage 104 typically has a half bridge leg for each phase of the BLDC motor 102. The controller 100 implements control loop and modulation functionality in software (e.g., firmware) to control the motor phase currents via the inverter stage 104.

Hall sensors, encoders, resolvers, or any other position sensing devices may be used to provide feedback to the controller 102 for determining motor position and speed. If a sensorless method is used, there is no need for position sensing. Sensorless methods may be implemented by back EMF (electromotive force) sensing or observers. The control loop functionality of the controller 102 determines the switching patterns for the individual (e.g., half bridge) legs of the inverter stage 104. The controller 100 implements trapezoidal control, also referred to as block commutation, to control the motor phase currents.

To this end, the BLDC controller 100 includes a reference signal generator 106 that generates a trapezoidal current reference signal I_n_ref for each phase of the BLDC motor 102, where ‘n’ is an integer indicating the phase number and n≥2. The controller 100 forces each phase current of the BLDC motor 102 to follow the trapezoidal current reference signal I_n_ref generated for that phase. That is, each trapezoidal current reference signal I_n_ref serves as a pattern, model, or example for the corresponding motor phase current such that the motor phase current resembles but does not necessarily identically match the trapezoidal current reference signal I_n_ref.

Each trapezoidal current reference signal I_n_ref forces the corresponding motor phase current to adhere to a ramp profile during commutation. The BLDC motor controller 100 forces the other phases to go through a similar ramp with the same rate. The trapezoidal ramp-based commutation control technique described herein avoids body diode power losses and results in smooth torque. During ramp down, the controller 102 forces active switching so that each phase current follows the corresponding ramp profile. Instead of doing this block-by-block, the controller 100 may create a phase reference for each phase current and force the current by using one or more control loops to follow the trapezoidal reference trajectories.

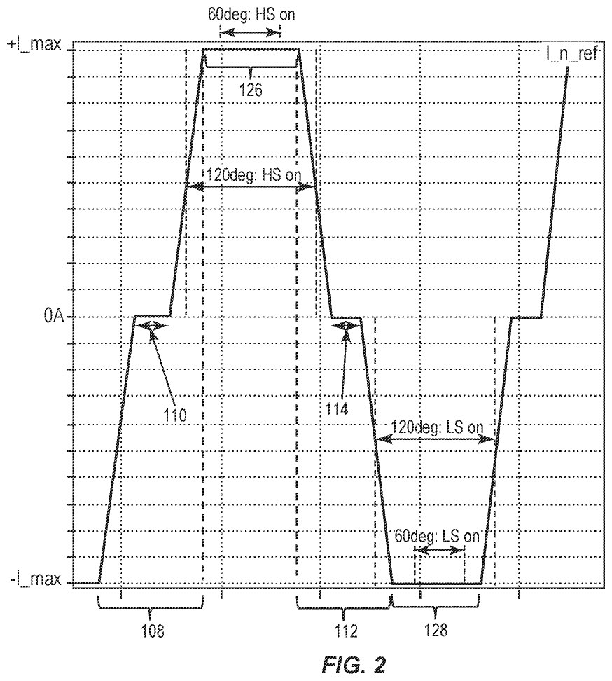

FIG. 2 illustrates the trapezoidal current reference signal I_n_ref for phase n of the BLDC motor 102. The trapezoidal current reference signal I_n_ref has a current ramp-up phase 108 with a step profile along which the trapezoidal current reference signal I_n_ref has zero slope for a portion 110 of the current ramp-up phase 108 and non-zero slope elsewhere. The trapezoidal current reference signal I_n_ref also has a current ramp-down phase 112 with a step profile along which the trapezoidal current reference signal I_n_ref has zero slope for a portion 114 of the current ramp-down phase 112 and non-zero slope elsewhere. The trapezoidal current reference signal I_n_ref is bounded by a positive maximum current limit +I_max and a negative maximum current limit −I_max, where |I_max| is the maximum current limit of the BLDC motor 102.

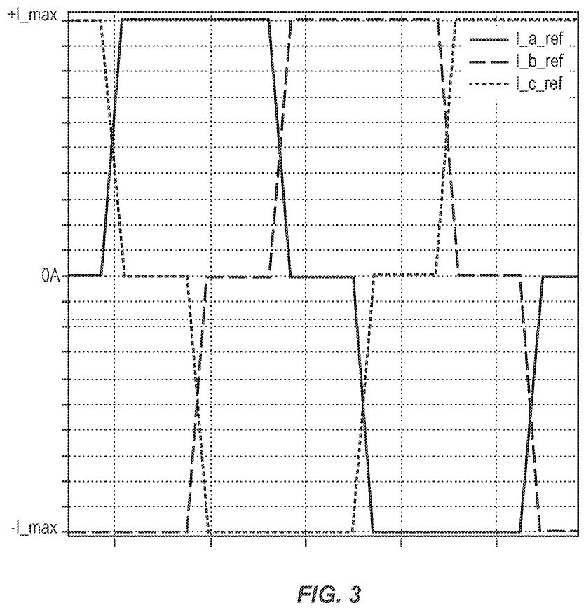

As shown in FIG. 3, each trapezoidal current reference signal I_n_ref generated by the reference signal generator 106 has the same shape as illustrated in FIG. 2, but are phase shifted relative to one another. For example, in the case of a 3-phase BLDC motor 102, the trapezoidal current reference signals I_a_ref, I_b_ref, I_c_ref are shifted by 120 degrees relative to one another.

The BLDC motor controller 100 also includes a control loop 116 for each phase of the BLDC motor 102. The control loop 116 shown in FIG. 1 is implemented using phase current feedback 120 and a PI (proportional-integral) control block 122 for each phase of the BLDC motor 102. However, this is just one example. Not every phase current may be monitored/measured as part of the feedback loop 120. The controller 100 may implement feedforward control without any phase current feedback. A different type of control block 122 may be used for the phases of the BLDC motor 102, e.g., such as a proportional control block, a proportional-integral-derivative control block, etc. Further embodiments of the control loop 116 are described later herein.

Phase current sensing may be implemented using any suitable current sensing technique. For example, current sensing may be implemented by a single shunt on either the power or ground path, a 3-shunt on either the high side or the low side of a phase, a 2-shunt on either the high side or the low side of a phase, in-line current sensing, a current sense FET, a power stage with integrated current sensing, etc.

Regardless of the type of current sensing employed, the BLDC motor controller 100 independently controls the duty cycle for each phase. In one embodiment, the control blocks 122 of the BLDC motor controller 100 generate PWM (pulse width modulation) signals PWM_n that force the respective motor phase currents to follow the corresponding trapezoidal current reference signal I_n_ref. Each control loop 116 of the BLDC motor controller 100 adjusts the duty cycle of the resulting switching control signal PWM_n for the inverter leg that energizes the corresponding phase of the BLDC motor 102, such that the current through the inverter leg follows the trapezoidal current reference signal I_n_ref for that phase.

Any suitable modulation scheme may be used to control the phase currents of the BLDC motor 102. For example, the BLDC motor controller 100 may include a modulator 124 that implements DPWM (discontinuous pulse-width modulation) or SVM (space vector modulation) in response to each switching control signal PWM_n generated by the corresponding control loop 116 of the BLDC motor controller 100. The DPWM and SVM modulation schemes shown in FIG. 1 are just two modulation examples of the modulation technique implemented by the modulator 124, and others are contemplated.

Each output S_n of the modulator 124 is used to drive the gates of the power switch devices that form the inverter leg that energize the corresponding phase of the BLDC motor 102. For example, the legs of the inverter stage 104 may be configured as half bridges implemented using, e.g., power MOSFETs (metal-oxide-semiconductor field-effect transistors), IGBTs (insulated-gate bipolar transistors), HEMTs (high-electron mobility transistors), etc. The switch devices may be fabricated using any suitable semiconductor technology such as Si, SiC, GaN, etc., and may include integrated current sensing capability.

As shown in FIGS. 2 and 3, for each electrical cycle of each trapezoidal current reference signal I_n_ref, the reference signal generator 106 generates the trapezoidal current reference signal I_n_ref to indicate that the high-side switch device and the low-side switch device of the corresponding inverter leg perform active switching during the current ramp-up phase 108 and the current ramp-down phase 112 and are off together for the portion 110 of the current ramp-up phase 108 and the portion 114 of the current ramp-down phase 112 when the trapezoidal current reference signal I_n_ref has zero slope. The high-side switch device and the low-side switch device of the same inverter leg are also off together during dead times which prevent shoot through (power rail to ground shorting). The trapezoidal current reference signal I_n_ref for each phase of the BLDC motor 102 also has a high-side on phase 126 that follows the current ramp-up phase 108, and a low-side on phase 128 that follows the current ramp-down phase 112.

In one embodiment, the high-side switch device of the corresponding inverter leg is on during the high-side on phase 126 and the low-side switch device is on during the low-side on phase 128. However, both the high-side switch device and the low-side switch device of the corresponding inverter leg may be switching even during at least a portion of the high-side on phase 126 and at least a portion of the low-side on phase 128.

For each electrical cycle of each trapezoidal current reference signal I_n_ref, the reference signal generator 106 may generate the trapezoidal current reference signal I_n_ref to indicate the following for the corresponding inverter leg: that the high-side switch device should be on and the low-side switch device off during at least part of the high-side on phase 126; and that the low-side switch device should be on and the high-side switch device off during at least part of the low-side on phase 128.

For each electrical cycle of each trapezoidal current reference signal I_n_ref, the reference signal generator 106 may generate the trapezoidal current reference signal I_n_ref to indicate the following for the corresponding inverter leg: that the high-side switch device and the low-side switch device should be off at the same time for 60 electrical degrees subtracting both the current ramp-up phase 108 and the current ramp-down phase 112.

By breaking down the entire electrical cycle to both switch devices of the corresponding inverter leg switching and both switch devices being off, the switching cycle implemented by the reference signal generator 106 may include any one of the following scenarios. Both switch devices may be switching. The high-side switch device may be on for 60 degrees (“60 deg: HS on” in FIG. 2), the low-side switch device may be on for a different 60 degrees (“60 deg: LS on” in FIG. 2), and both switch devices may be switching for the remainder of the switching cycle. The high-side switch device may be on for 120 degrees (“120 deg: HS on” in FIG. 2) and both switch devices may be switching for the remainder of the switching cycle. The low-side switch device may be on for 120 degrees (“120 deg: LS on” in FIG. 2) and both switch devices may be switching for the remainder of the switching cycle.

In one embodiment, the reference signal generator 106 generates the trapezoidal current reference signal I_n_ref for each phase of the BLDC motor 102 based on the maximum current limit I_max of the BLDC motor 102, a ramp signal ‘ramp_phase’ for the motor phase, and a rotor position estimate θ_I for the motor phase. The rotor position estimate θ_I may be determined from a rotor position estimate θ for the BLDC motor 102. Depending on the phase that is under consideration, the rotor position estimate θ_I may be phase shifted. The rotor position estimate θ for the BLDC motor 102 may be determined using a Hall sensor, the back EMF of the motor 102, etc.

In FIG. 1, the BLDC motor controller 100 may take the time derivate 130 of the rotor position estimate θ for the BLDC motor 102 to derive a speed estimate s for the motor 102, and compare the speed estimate ŝ to a speed command ‘Speed CMD’ to generate a speed error signal ē. A control block 132 such as a PI control block determines the maximum current I_max for the BLDC motor 102 from the speed error signal ē.

The reference signal generator 106 shifts the rotor position estimate θ based on the number of phases. For example, the reference signal generator 106 may shift the rotor position estimate θ by 2π/3 for phase a of the BLDC motor 102 and by −2π/3 for phase c of the BLDC motor 102. In this three-phase example, θ_I=θ for phase b of the BLDC motor 102. The algorithm implemented by the reference signal generator 106 to generate the trapezoidal current reference signal I_n_ref for each phase of the BLDC motor 102 may be expressed as a series of if and else-if conditions, as an example. Software (e.g., firmware) used to implement the reference signal generator algorithm may be implemented in other ways without departing from the intended scope of coverage-generating the trapezoidal current reference signal I_n_ref in FIG. 2 with the step profile.

For each if and else-if condition, an exemplary range of θ_I values may be provided by the reference signal generator 106 when the corresponding condition is satisfied. For example, the trapezoidal current reference signal I_n_ref for the phase under consideration is set to zero when the rotor position estimate θ_I is greater than 300 degrees but less than 330 degrees minus the ramp signal ramp_phase divided by two. This condition corresponds to the portion 110 of the current ramp-up phase 108 when the trapezoidal current reference signal I_n_ref has zero slope. For θ_I between 120 and 300 degrees, the reference signal generator 106 may use the same function to produce the negative values for the trapezoidal current reference signal I_n_ref.

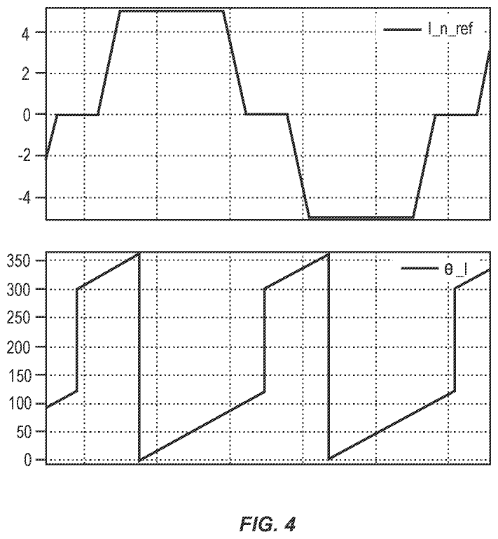

FIG. 4 illustrates an example of the rotor position estimate θ_I and the resulting trapezoidal current reference signal I_n_ref produced by the signal generation algorithm implemented by the reference signal generator 106 for the phase under consideration. In one embodiment, the ramp signal ramp_phase input to the signal generation algorithm implemented by the reference signal generator 106 has an adjustable ramp rate. For example, the ramp rate of the ramp signal input ramp_phase may be adjusted by the BLDC motor controller 100 using phase current feedback.

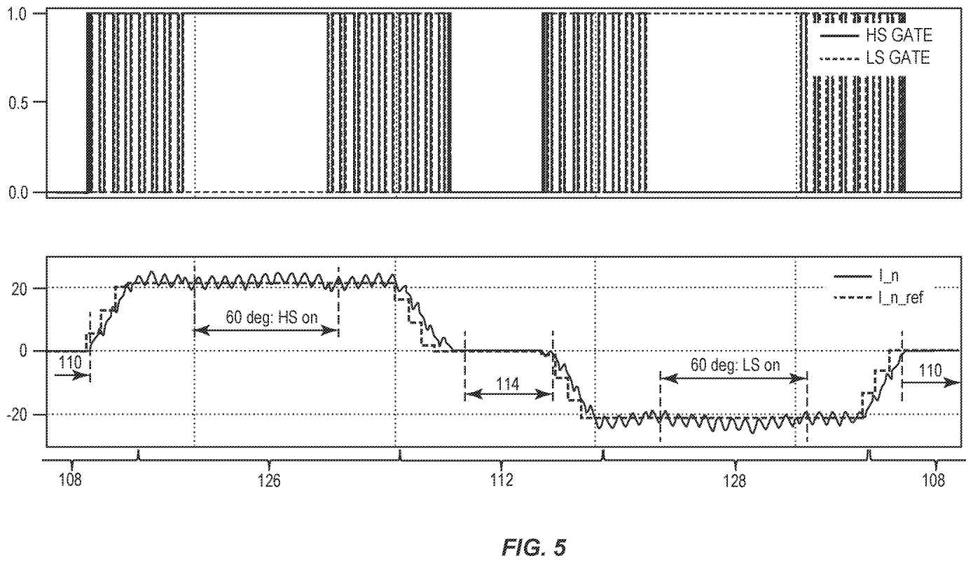

FIG. 5 illustrates various waveforms associated with controlling the BLDC motor 102 using the trapezoidal current reference signal I_n_ref for the nth phase of the motor 102. The upper graph plots the gate voltage ‘HS gate’ for the high-side switch device of the inverter leg for the nth phase and the gate voltage ‘LS gate’ for the corresponding low-side switch device of the inverter leg. The lower graph plots the trapezoidal current reference signal I_n_ref and the resulting current ‘I_n’ for the nth phase of the BLDC motor 102. As shown in FIG. 5, the trapezoidal current reference signal I_n_ref serves as a pattern, model, or example for the nth phase current I_n of the motor 102 such that the phase current I_n resembles but does not necessarily identically match the trapezoidal current reference signal I_n_ref.

In the example illustrated in FIG. 5, the high-side switch device and the low-side switch device of the inverter leg are fully on individually for 60 degrees during the high-side on phase 126 and the low-side on phase 128, respectively (“60 deg: HS on” and “60 deg: LS on” in FIG. 5). Both switch devices of the inverter leg are off at the same time for the portion 110 of the current ramp-up phase 108 and the portion 114 of the current ramp-down phase 112 when the trapezoidal current reference signal I_n_ref has zero slope. The remainder of the cycle is active synchronous rectifier switching. Accordingly, the body diode associated with each switch device only conducts during dead time.

The trapezoidal-based motor control technique described herein reduces power loss, reduces heatsink and system board size, reduces torque ripple, reduces acoustic noise, increases single cycle battery life, and increases motor runtime. To achieve higher performance and maximum efficiency, the controller 100 may implement a FOC (field-oriented control) method with a sinusoidal back-emf motor 102, which means the same BLDC motor with trapezoidal back-emf can be used to achieve maximum efficiency and performance. As explained previously herein, the control loop 116 for each phase of the BLDC motor 102 may be implemented in many ways, some embodiments of which were previously described in connection with FIGS. 1 through 5.

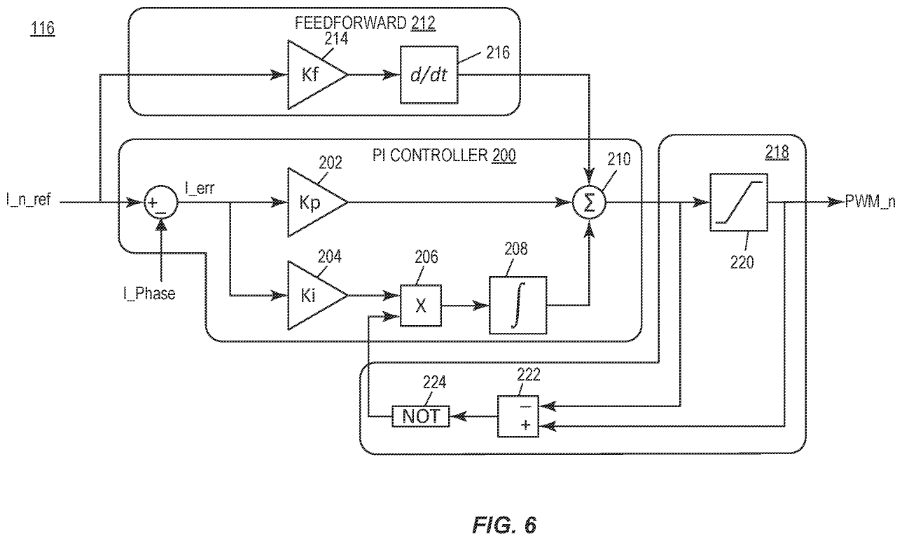

FIG. 6 illustrates a block diagram of an embodiment of the control loop 116 for the nth phase of the BLDC motor 102. According to this embodiment, the control loop 116 includes a feedback control loop 200 that tracks a difference ‘I_err’ between the trapezoidal current reference signal I_n_ref for the nth phase and a measure or estimate I_Phase of the phase current, and adjusts the duty cycle of the PWM signal ‘PWM_n’ so as to reduce the difference.

More generally, the BLDC motor controller 100 may use any form of feedback about the motor behavior to adjust the trapezoidal current reference signal I_n_ref. For example, one or more of the phase currents may be sampled and the controller 100 may use the current samples to force the corresponding phase current to follow a certain shape. The actual phase current may be measured, e.g., by a Hall effect sensor, or the current of the low-side switch device of that phase may be measured and the controller 100 may relate this current information to the actual phase current. Ideally, each phase current follows the ramp profile of the corresponding trapezoidal current reference signal I_n_ref. To this end, the controller 100 forces the phase currents to follow the ramp profiles.

FIG. 6 uses an example of a PI control block for implementing the feedback control loop 200, where the PI control block has a proportional term (Kp) 202, an integral term (Ki) 204, a multiplier 206, an integrator 208, and a summing block 210. A different type of control block 116 may be used, e.g., such as a proportional control block, a proportional-integral-derivative control block, etc.

As shown in FIG. 6, the control loop 116 for the nth phase of the BLDC motor 102 may further include a feedforward control loop 212 that processes the trapezoidal current reference signal I_n_ref for the nth phase. The feedforward control loop 212 provides a faster and more accurate dynamic response during the current ramp-up and ramp-down phases 108, 112 of the trapezoidal current reference signal I_n_ref. The feedback control loop 200 may adjust the duty cycle of the PWM signal ‘PWM_n’ further based on the output of the feedforward control loop 212, in this example. In FIG. 6, the feedforward control loop 212 includes a feedforward term (Kf) 214 and a derivative block 216 for processing the trapezoidal current reference signal I_n_ref, as an example. The feedforward term (Kf) 214 may be a constant gain or a gain that is adapted to the operating point of the system.

As shown in FIG. 6, the control loop 116 for the nth phase of the BLDC motor 102 may also include an anti-windup loop 218 to prevent saturation of the feedback control loop integrator 208. The anti-windup loop 218 may include a filter 220 which is applied to the PWM signal, and an incrementer/decrementer 222 and a logic NOT function 224 for adjusting the filtered PWM signal.

In another embodiment, the control loop 116 for each phase of the BLDC motor 102 omits the feedback control loop 200 and the anti-windup loop 218 but includes the feedforward control loop 212. According to this embodiment, the control loop 116 for each phase of the BLDC motor 102 adjusts the duty cycle of the PWM signal based on the output of the feedforward control loop 212, without any phase current feedback. Each control loop 116 may also include a classic controller (not shown in FIG. 6), where the feedforward control loop 112 and the classic controller together determine the duty cycle of the PWM signal. As used herein, the term ‘classic controller’ may refer to a P (proportional) controller, an I (integral) controller, a PI controller, a PID controller, a Type I controller, a Type II controller, or a Type III controller.

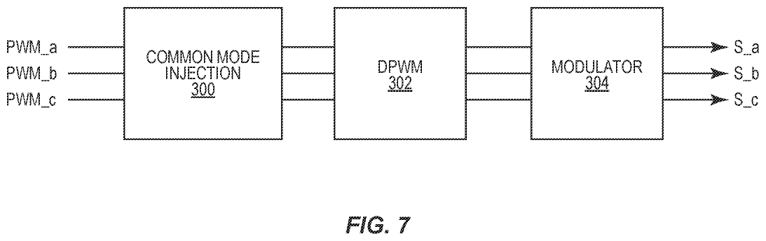

FIG. 7 illustrates a block diagram of an embodiment of the modulation functionality implemented by the BLDC motor controller 100. According to this embodiment, a common mode injection block 300 is used to increase the DC link voltage utilization, e.g., to roughly 15%. In the case of DPWM, a DPWM block 302 keeps the high-side or low-side switch device of the corresponding phase on for 60 degrees during the high-side on phase 126 and the low-side on phase 128, respectively, of the trapezoidal current reference signal I_n_ref. A modulation block 304 compares the final PWM values with a carrier signal to create the final switching pattern S_n for each leg (e.g., half bridge) of the inverter stage 104. Other modulation schemes such as SVM, PWM, etc. can be used along with the trapezoidal ramp-based commutation control technique described herein.

Although the present disclosure is not so limited, the following numbered examples demonstrate one or more aspects of the disclosure.

Example 1. A method of controlling a BLDC (brushless DC) motor having a plurality of phases each energized by a different leg of an inverter, the method comprising: generating a trapezoidal current reference signal for each phase of the BLDC motor that has a current ramp-up phase with a step profile along which the trapezoidal current reference signal has zero slope for a portion of the current ramp-up phase and non-zero slope elsewhere, and a current ramp-down phase with a step profile along which the trapezoidal current reference signal has zero slope for a portion of the current ramp-down phase and non-zero slope elsewhere; and adjusting a duty cycle of a switching control signal for each leg of the inverter, such that a current through each inverter leg follows the trapezoidal current reference signal for the corresponding phase.

Example 2. The method of example 1, wherein for each electrical cycle of each trapezoidal current reference signal, the trapezoidal current reference signal is generated to indicate that a high-side switch device and a low-side switch device of the corresponding inverter leg perform active switching during the current ramp-up phase and the current ramp-down phase and are off together only for the portion of the current ramp-up phase and the portion of the current ramp-down phase when the trapezoidal current reference signal has zero slope.

Example 3. The method of example 2, wherein the trapezoidal current reference signal for each phase of the BLDC motor has a high-side on phase that follows the current ramp-up phase and a low-side on phase that follows the current ramp-down phase.

Example 4. The method of example 3, wherein for each electrical cycle of each trapezoidal current reference signal, the trapezoidal current reference signal is generated to indicate the following for the corresponding inverter leg: that the high-side switch device should be on and the low-side switch device off during at least part of the high-side on phase; and that the low-side switch device should be on and the high-side switch device off during at least part of the low-side on phase.

Example 5. The method of example 3 or 4, wherein for each electrical cycle of each trapezoidal current reference signal, the trapezoidal current reference signal is generated to indicate the following for the corresponding inverter leg: that the high-side switch device and the low-side switch device should be off at the same time for 60 electrical degrees subtracting both the current ramp-up phase and the current ramp-down phase.

Example 6. The method of any of examples 1 through 5, wherein the trapezoidal current reference signal for each phase of the BLDC motor is generated based on a maximum current level for the BLDC, a ramp signal for the phase, and a rotor position estimate for the phase.

Example 7. The method of example 6, wherein the ramp signal has an adjustable ramp rate.

Example 8. The method of any of examples 1 through 7, wherein adjusting the duty cycle of the switching control signal for each leg of the inverter comprises: tracking a difference between the trapezoidal current reference signal for the corresponding phase and a measure or estimate of the phase current; and adjusting the duty cycle so as to reduce the difference.

Example 9. The method of example 8, wherein adjusting the duty cycle of the switching control signal for each leg of the inverter further comprises: inputting the trapezoidal current reference signal for the corresponding phase into a feedforward control loop; and adjusting the duty cycle based on the difference between the trapezoidal current reference signal for the corresponding phase and the measure or estimate of the phase current, and based on an output of the feedforward control loop.

Example 10. The method of any of examples 1 through 7, wherein adjusting the duty cycle of the switching control signal for each leg of the inverter comprises: inputting the trapezoidal current reference signal for the corresponding phase into a feedforward control loop; and adjusting the duty cycle based on an output of the feedforward control loop, without any phase current feedback.

Example 11. A controller for a BLDC (brushless DC) motor having a plurality of phases each energized by a different leg of an inverter, the controller comprising: a signal generator configured to generate a trapezoidal current reference signal for each phase of the BLDC motor that has a current ramp-up phase with a step profile along which the trapezoidal current reference signal has zero slope for a portion of the current ramp-up phase and non-zero slope elsewhere, and a current ramp-down phase with a step profile along which the trapezoidal current reference signal has zero slope for a portion of the current ramp-down phase and non-zero slope elsewhere; and a control loop for each phase of the BLDC motor and that is configured to adjust a duty cycle of a switching control signal for the inverter leg that energizes the phase, such that a current through the inverter leg follows the trapezoidal current reference signal for the phase.

Example 12. The controller of example 11, wherein for each electrical cycle of each trapezoidal current reference signal, the signal generator is configured to generate the trapezoidal current reference signal to indicate that a high-side switch device and a low-side switch device of the corresponding inverter leg perform active switching during the current ramp-up phase and the current ramp-down phase and are off together only for the portion of the current ramp-up phase and the portion of the current ramp-down phase when the trapezoidal current reference signal has zero slope.

Example 13. The controller of example 12, wherein the trapezoidal current reference signal for each phase of the BLDC motor has a high-side on phase that follows the current ramp-up phase and a low-side on phase that follows the current ramp-down phase.

Example 14. The controller of example 13, wherein for each electrical cycle of each trapezoidal current reference signal, the signal generator is configured to generate the trapezoidal current reference signal to indicate the following for the corresponding inverter leg: that the high-side switch device should be on and the low-side switch device off during at least part of the high-side on phase; and that the low-side switch device should be on and the high-side switch device off during at least part of the low-side on phase.

Example 15. The controller of example 13 or 14, wherein for each electrical cycle of each trapezoidal current reference signal, the signal generator is configured to generate the trapezoidal current reference signal to indicate the following for the corresponding inverter leg: that the high-side switch device and the low-side switch device should be off at the same time for 60 electrical degrees subtracting both the current ramp-up phase and the current ramp-down phase.

Example 16. The controller of any of examples 11 through 15, wherein the signal generator is configured to generate the trapezoidal current reference signal for each phase of the BLDC motor based on a maximum current level for the BLDC, a ramp signal for the phase, and a rotor position estimate for the phase.

Example 17. The controller of example 16, wherein the ramp signal has an adjustable ramp rate.

Example 18. The controller of any of examples 11 through 17, wherein the control loop for each phase of the BLDC motor comprises a feedback control loop configured to: track a difference between the trapezoidal current reference signal for the phase and a measure or estimate of the phase current; and adjust the duty cycle so as to reduce the difference.

Example 19. The controller of example 18, wherein the control loop for each phase of the BLDC motor further comprises a feedforward control loop configured to process the trapezoidal current reference signal for the phase, and wherein the feedback control loop for the phase is configured to adjust the duty cycle based on the difference between the trapezoidal current reference signal for the phase and the measure or estimate of the phase current, and based on an output of the feedforward control loop for the phase.

Example 20. The controller of any of examples 11 through 17, wherein the control loop for each phase of the BLDC motor comprises a feedforward control loop configured to: process the trapezoidal current reference signal for the phase; and adjust the duty cycle based on an output of the feedforward control loop, without any phase current feedback.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to include all possible conjunctive and disjunctive combinations, unless expressly noted otherwise. For example, the expression “A and/or B” should be interpreted to mean only A, only B, or both A and B. The expression “at least one of” should be interpreted in the same manner as “and/or”, unless expressly noted otherwise. For example, the expression “at least one of A and B” should be interpreted to mean only A, only B, or both A and B.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of controlling a BLDC (brushless DC) motor having a plurality of phases each energized by a different leg of an inverter, the method comprising:
generating a trapezoidal current reference signal for each phase of the BLDC motor that has a current ramp-up phase with a step profile along which the trapezoidal current reference signal has zero slope for a portion of the current ramp-up phase and non-zero slope elsewhere, and a current ramp-down phase with a step profile along which the trapezoidal current reference signal has zero slope for a portion of the current ramp-down phase and non-zero slope elsewhere; and
adjusting a duty cycle of a switching control signal for each leg of the inverter, such that a current through each inverter leg is forced to follow the trapezoidal current reference signal for the corresponding phase.

2. The method of claim 1, wherein for each electrical cycle of each trapezoidal current reference signal, the trapezoidal current reference signal is generated to indicate that a high-side switch device and a low-side switch device of the corresponding inverter leg perform active switching during the current ramp-up phase and the current ramp-down phase and are off together for the portion of the current ramp-up phase and the portion of the current ramp-down phase when the trapezoidal current reference signal has zero slope.

3. The method of claim 2, wherein the trapezoidal current reference signal for each phase of the BLDC motor has a high-side on phase that follows the current ramp-up phase and a low-side on phase that follows the current ramp-down phase.

4. The method of claim 3, wherein for each electrical cycle of each trapezoidal current reference signal, the trapezoidal current reference signal is generated to indicate the following for the corresponding inverter leg:
that the high-side switch device should be on and the low-side switch device off during at least part of the high-side on phase; and
that the low-side switch device should be on and the high-side switch device off during at least part of the low-side on phase.

5. The method of claim 3, wherein for each electrical cycle of each trapezoidal current reference signal, the trapezoidal current reference signal is generated to indicate the following for the corresponding inverter leg:
that the high-side switch device and the low-side switch device should be off at the same time for 60 electrical degrees subtracting both the current ramp-up phase and the current ramp-down phase.

6. The method of claim 1, wherein the trapezoidal current reference signal for each phase of the BLDC motor is generated based on a maximum current level for the BLDC, a ramp signal for the phase, and a rotor position estimate for the phase.

7. The method of claim 6, wherein the ramp signal has an adjustable ramp rate.

8. The method of claim 1, wherein adjusting the duty cycle of the switching control signal for each leg of the inverter comprises:
tracking a difference between the trapezoidal current reference signal for the corresponding phase and a measure or estimate of the phase current; and
adjusting the duty cycle so as to reduce the difference.

9. The method of claim 8, wherein adjusting the duty cycle of the switching control signal for each leg of the inverter further comprises:
inputting the trapezoidal current reference signal for the corresponding phase into a feedforward control loop; and
adjusting the duty cycle based on the difference between the trapezoidal current reference signal for the corresponding phase and the measure or estimate of the phase current, and based on an output of the feedforward control loop.

10. The method of claim 1, wherein adjusting the duty cycle of the switching control signal for each leg of the inverter comprises:
inputting the trapezoidal current reference signal for the corresponding phase into a feedforward control loop; and
adjusting the duty cycle based on an output of the feedforward control loop, without any phase current feedback.

11. A controller for a BLDC (brushless DC) motor having a plurality of phases each energized by a different leg of an inverter, the controller comprising:
a signal generator configured to generate a trapezoidal current reference signal for each phase of the BLDC motor that has a current ramp-up phase with a step profile along which the trapezoidal current reference signal has zero slope for a portion of the current ramp-up phase and non-zero slope elsewhere, and a current ramp-down phase with a step profile along which the trapezoidal current reference signal has zero slope for a portion of the current ramp-down phase and non-zero slope elsewhere; and
a control loop for each phase of the BLDC motor and that is configured to adjust a duty cycle of a switching control signal for the inverter leg that energizes the phase, such that a current through the inverter leg is forced to follow the trapezoidal current reference signal for the phase.

12. The controller of claim 11, wherein for each electrical cycle of each trapezoidal current reference signal, the signal generator is configured to generate the trapezoidal current reference signal to indicate that a high-side switch device and a low-side switch device of the corresponding inverter leg perform active switching during the current ramp-up phase and the current ramp-down phase and are off together for the portion of the current ramp-up phase and the portion of the current ramp-down phase when the trapezoidal current reference signal has zero slope.

13. The controller of claim 12, wherein the trapezoidal current reference signal for each phase of the BLDC motor has a high-side on phase that follows the current ramp-up phase and a low-side on phase that follows the current ramp-down phase.

14. The controller of claim 13, wherein for each electrical cycle of each trapezoidal current reference signal, the signal generator is configured to generate the trapezoidal current reference signal to indicate the following for the corresponding inverter leg:
that the high-side switch device should be on and the low-side switch device off during at least part of the high-side on phase; and
that the low-side switch device should be on and the high-side switch device off during at least part of the low-side on phase.

15. The controller of claim 13, wherein for each electrical cycle of each trapezoidal current reference signal, the signal generator is configured to generate the trapezoidal current reference signal to indicate the following for the corresponding inverter leg:
that the high-side switch device and the low-side switch device should be off at the same time for 60 electrical degrees subtracting both the current ramp-up phase and the current ramp-down phase.

16. The controller of claim 11, wherein the signal generator is configured to generate the trapezoidal current reference signal for each phase of the BLDC motor based on a maximum current level for the BLDC, a ramp signal for the phase, and a rotor position estimate for the phase.

17. The controller of claim 16, wherein the ramp signal has an adjustable ramp rate.

18. The controller of claim 11, wherein the control loop for each phase of the BLDC motor comprises a feedback control loop configured to:
track a difference between the trapezoidal current reference signal for the phase and a measure or estimate of the phase current; and
adjust the duty cycle so as to reduce the difference.

19. The controller of claim 18, wherein the control loop for each phase of the BLDC motor further comprises a feedforward control loop configured to process the trapezoidal current reference signal for the phase, and wherein the feedback control loop for the phase is configured to adjust the duty cycle based on the difference between the trapezoidal current reference signal for the phase and the measure or estimate of the phase current, and based on an output of the feedforward control loop for the phase.

20. The controller of claim 11, wherein the control loop for each phase of the BLDC motor comprises a feedforward control loop configured to:
process the trapezoidal current reference signal for the phase; and
adjust the duty cycle based on an output of the feedforward control loop, without any phase current feedback.
